(19) United States
(12) Patent Application Publication
(10) Pub. No.: US 2025/0045419 A1
(43) Pub. Date: Feb. 6, 2025

(54) SELECTIVE SCREEN CAPTURE PROTECTION ON VIRTUAL DESKTOP SESSIONS

(71) Applicant: Cloud Software Group, Inc., Fort Lauderdale, FL (US)

(72) Inventors: Vikram Bhagwat, Pune (IN); Siddheshwar Kamatar, Bangalore (IN); Santosh Sampath, Bangalore (IN)

(21) Appl. No.: 18/362,228

(22) Filed: Jul. 31, 2023

(51) Int. Cl. G06F 21/60; G06F 9/451

(52) U.S. Cl. CPC G06F 21/60; G06F 9/452

(57) ABSTRACT

In one aspect, an example methodology may include, by a computing device, establishing a virtual desktop session with an endpoint and retrieving a screen capture protection policy defining one or more sensitive applications for screen capture protection. The method may also include, responsive to a determination that a sensitive application is visible on a screen, enabling, by the computing device, screen capture protection on the virtual desktop session, wherein the determination that the sensitive application is visible is based on the screen capture protection policy.

### BACKGROUND

Use of virtual desktops and/or virtual applications is becoming prevalent as a greater percentage of the workforce conducts business from decentralized office facilities. For example, organizations may deploy virtual desktops and applications to allow users, such as employees, to access and use the virtual desktops and applications from virtually any location using a connected device.

Application virtualization enables applications to run without dependencies through another operating system (OS) or browser. Application virtualization software allows users to access and use an application from a separate device than the one on which the application is installed. Desktop virtualization separates the desktop environment and its applications from the physical client device used to access it. Desktop virtualization depends on application virtualization. Desktop and application virtualization is typically based on a client-server model, and may be deployed using a management server which may be hosted in the cloud or on-premises. For example, a user can use a client device and establish a remote computing session with the management server to access resources, such as applications, files, and data, via their virtual desktop.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

During a virtual desktop session, a user is able to screen capture the active or in progress virtual desktop session and share the captured screen with other users. However, screen capture of a virtual desktop session can result in loss of sensitive information when a sensitive application is visible on the desktop. To prevent loss of sensitive information, some virtual desktop providers provide a screen capture protection feature that prevents the remote desktop window from being captured on client endpoints. When the screen capture protection feature is enabled, screen capture protection is enforced the moment a protected virtual desktop session starts running irrespective of the applications running in the virtual desktop session. It is recognized herein that providing screen capture protection on the entire virtual desktop session can be highly inefficient since the protection is applied to all applications running in the virtual desktop session. For example, when the screen capture protection feature is enabled, a user is prohibited from screen sharing non-sensitive applications running in the virtual desktop session thus affecting the user's ability to effectively collaborate. Embodiments of the present disclosure can enhance, among other aspects, the ability of users to screen share non-sensitive applications by providing selective screen capture protection on virtual desktop sessions.

In accordance with one example embodiment provided to illustrate the broader concepts, systems, and techniques described herein, a method includes, by a computing device, establishing a virtual desktop session with an endpoint and retrieving a screen capture protection policy defining one or more sensitive applications for screen capture protection. The method also includes, responsive to a determination that a sensitive application is visible on a screen, enabling, by the computing device, screen capture protection on the virtual desktop session, wherein the determination that the sensitive application is visible is based on the screen capture protection policy.

In some embodiments, enabling the screen capture protection includes sending an enable notification to the endpoint to enable the screen capture protection at the endpoint, so as to prevent screen capture of the screen at the endpoint.

In some embodiments, enabling the screen capture protection includes sending an enable notification with sensitive region information to the endpoint to enable a region-based screen capture protection at the endpoint, so as to prevent screen capture of a region of the screen at the endpoint, wherein the region of the screen is determined from the sensitive region information.

In some embodiments, the method also includes, responsive to a determination that no sensitive application is visible on the screen, disabling, by the computing device, screen capture protection on the virtual desktop session. In some embodiments, disabling the screen capture protection includes sending a disable notification to the endpoint to disable the screen capture protection at the endpoint. In some embodiments, disabling the screen capture protection includes sending a disable notification to the endpoint to disable a region-based screen capture protection at the endpoint.

In some embodiments, the method further includes, responsive to a reconnect of the virtual desktop session and responsive to a determination that at least one sensitive application is visible on a screen, enabling, by the computing device, screen capture protection on the virtual desktop session, wherein the determination that the at least one sensitive application is visible is based on the screen capture protection policy.

In accordance with another example embodiment provided to illustrate the broader concepts, systems, and techniques described herein, a method includes, by a computing device, establishing a virtual desktop session with an endpoint and retrieving a screen capture protection policy defining one or more sensitive applications for screen capture protection. The method also includes, responsive to a determination of a screen capture or screen recording event on the virtual desktop session screen at the endpoint, enabling, by the computing device, screen capture protection on one or more sensitive applications running within the virtual desktop session, wherein the one or more sensitive applications are determined based on the screen capture protection policy.

In some embodiments, the determination of the screen capture or screen recording event on the virtual desktop session screen at the endpoint is based on a notification from the endpoint informing of a launch of the screen capture or screen recording event on the virtual desktop session screen at the endpoint.

In some embodiments, enabling screen capture protection on one or more sensitive applications running within the virtual desktop session causes the one or more sensitive applications to be not visible on a screen.

In some embodiments, enabling screen capture protection on one or more sensitive applications running within the virtual desktop session includes invoking a function provided by an underlying operating system (OS) on the one or more sensitive applications.

In some embodiments, the method also includes, responsive to a determination of a completion of the screen capture or screen recording event on the virtual desktop session screen at the endpoint, disabling, by the computing device, screen capture protection on the one or more sensitive applications running within the virtual desktop session. In one aspect, the determination of the completion of the screen capture or screen recording event on the virtual desktop session screen at the endpoint is based on a notification from the endpoint informing of the completion of the screen capture or screen recording event on the virtual desktop session screen at the endpoint.

According to another illustrative embodiment provided to illustrate the broader concepts described herein, a computing device includes a processor and a non-volatile memory storing computer program code that when executed on the processor, causes the processor to execute a process corresponding to any one of the aforementioned methods or any described embodiment thereof.

According to another illustrative embodiment provided to illustrate the broader concepts described herein, a non-transitory machine-readable medium encodes instructions that when executed by one or more processors cause a process to be carried out, the process corresponding to any one of the aforementioned methods or any described embodiment thereof.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4A is a block diagram of an illustrative system in which resource management services may manage and streamline access by clients to resource feeds (via one or more gateway services) and/or software-as-a-service (SaaS) applications.

FIG. 4B is a block diagram showing an illustrative implementation of the system shown in FIG. 4A in which various resource management services as well as a gateway service are located within a cloud computing environment.

FIG. 4C is a block diagram similar to FIG. 4B but in which the available resources are represented by a single box labeled “systems of record,” and further in which several different services are included among the resource management services.

FIG. 5 is a diagram of an illustrative system for selective screen capture protection on virtual desktop sessions, in accordance with an embodiment of the present disclosure.

FIG. 6 is a sequence diagram showing an example flow of interactions between various components to provide selective screen capture protection, in accordance with an embodiment of the present disclosure.

FIG. 7 is a sequence diagram showing an example flow of interactions between various components to provide selective region-based screen capture protection, in accordance with an embodiment of the present disclosure.

FIG. 8 is a sequence diagram showing an example flow of interactions between various components to enforce screen capture protection for a sensitive application running within a virtual desktop session, in accordance with an embodiment of the present disclosure.

### DETAILED DESCRIPTION

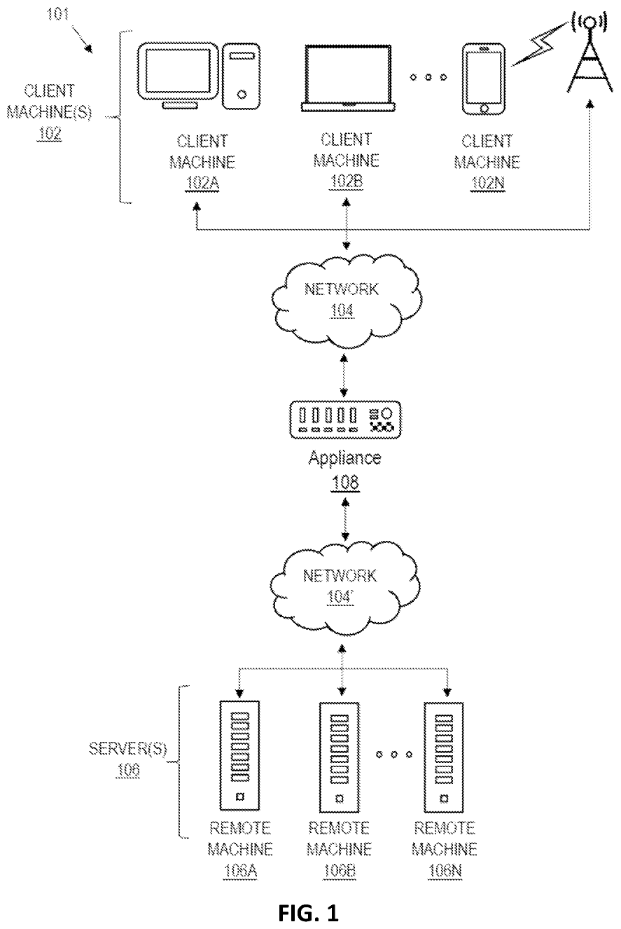

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VOIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

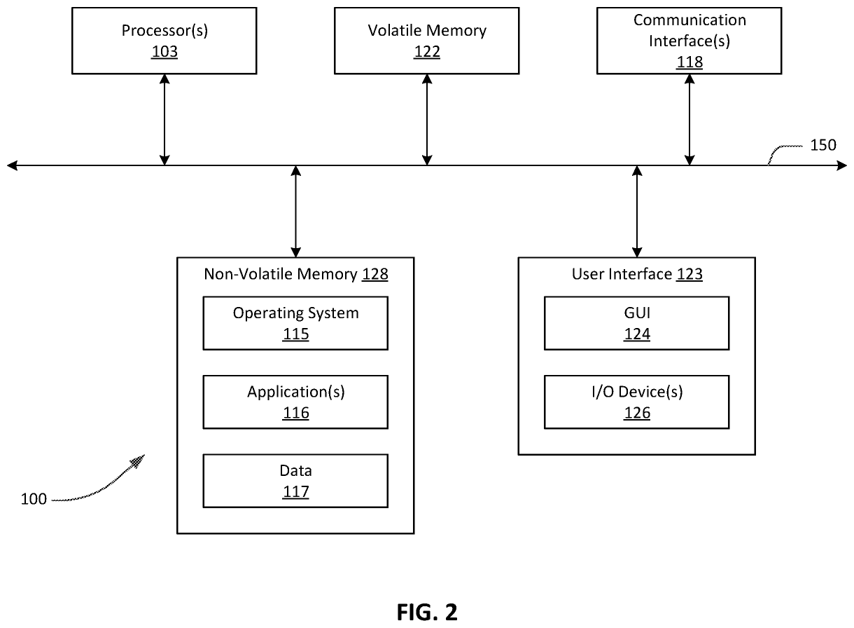

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital, or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

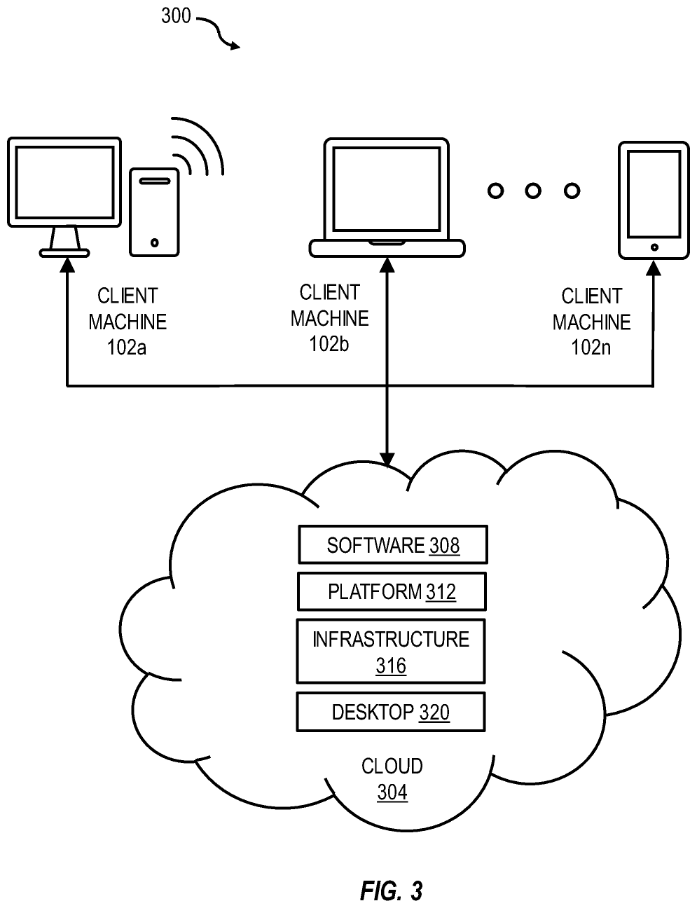

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers, or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers, or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files, and desktops together (whether on-premises or in the cloud) to deliver a unified experience.

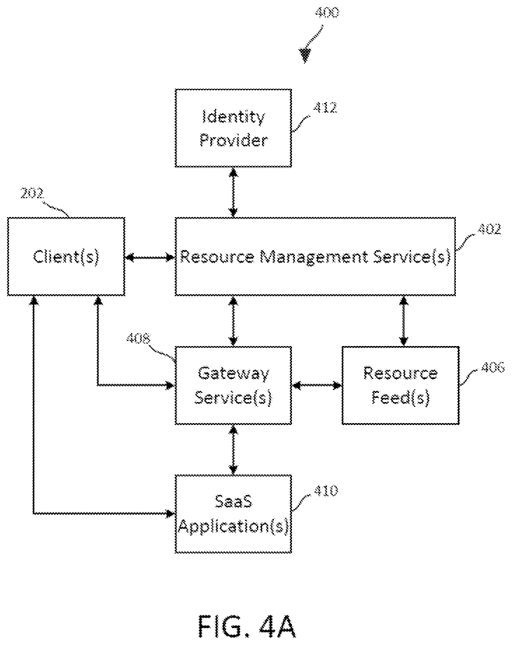

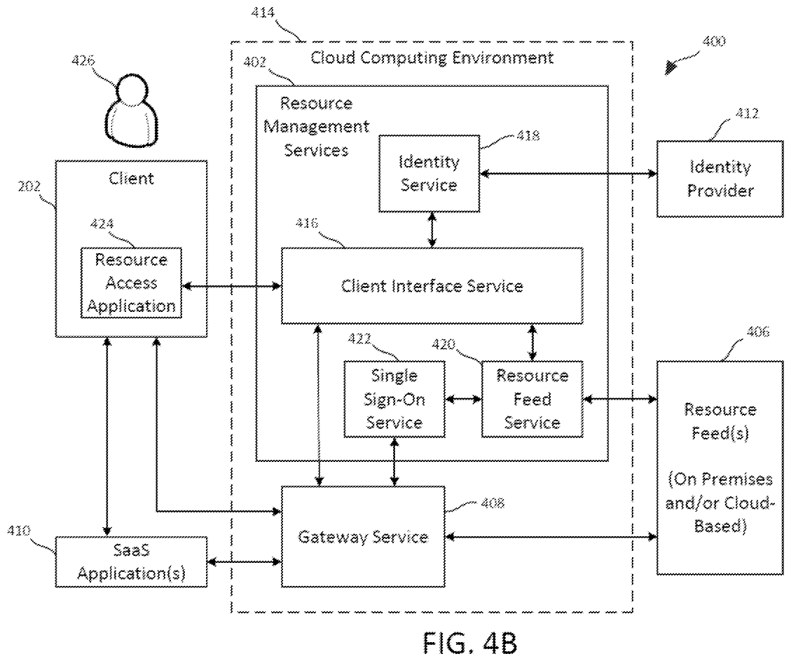

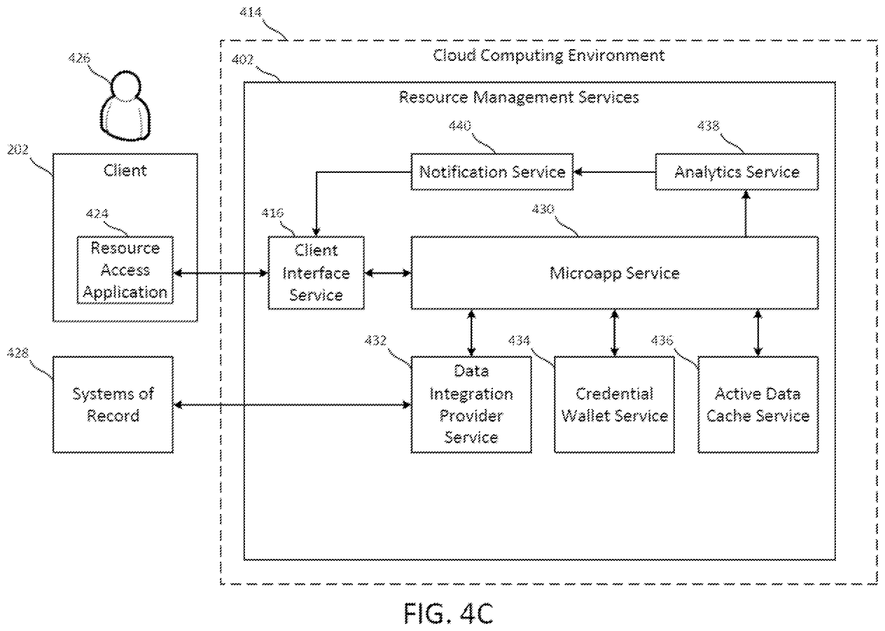

FIG. 4A is a block diagram of an illustrative system 400 in which one or more resource management services 402 may manage and streamline access by one or more clients 202 to one or more resource feeds 406 (via one or more gateway services 408) and/or one or more software-as-a-service (SaaS) applications 410. In particular, resource management service(s) 402 may employ an identity provider 412 to authenticate the identity of a user of a client 202 and, following authentication, identify one of more resources the user is authorized to access. In response to the user selecting one of the identified resources, resource management service(s) 402 may send appropriate access credentials to the requesting client 202, and the requesting client 202 may then use those credentials to access the selected resource. For resource feed(s) 406, client 202 may use the supplied credentials to access the selected resource via gateway service 408. For SaaS application(s) 410, client 202 may use the credentials to access the selected application directly.

Client(s) 202 may be any type of computing devices capable of accessing resource feed(s) 406 and/or SaaS application(s) 410, and may, for example, include a variety of desktop or laptop computers, smartphones, tablets, etc. Resource feed(s) 406 may include any of numerous resource types and may be provided from any of numerous locations. In some embodiments, for example, resource feed(s) 406 may include one or more systems or services for providing virtual applications and/or desktops to client(s) 202, one or more file repositories and/or file sharing systems, one or more secure browser services, one or more access control services for SaaS applications 410, one or more management services for local applications on client(s) 202, one or more internet enabled devices or sensors, etc. Each of resource management service(s) 402, resource feed(s) 406, gateway service(s) 408, SaaS application(s) 410, and identity provider 412 may be located within an on-premises data center of an organization for which system 400 is deployed, within one or more cloud computing environments, or elsewhere.

FIG. 4B is a block diagram showing an illustrative implementation of system 400 shown in FIG. 4A in which various resource management services 402 as well as gateway service 408 are located within a cloud computing environment 414. The cloud computing environment may, for example, include Microsoft Azure Cloud, Amazon Web Services, Google Cloud, or IBM Cloud.

For any of illustrated components (other than client 202) that are not based within cloud computing environment 414, cloud connectors (not shown in FIG. 4B) may be used to interface those components with cloud computing environment 414. Such cloud connectors may, for example, run on Windows Server instances hosted in resource locations and may create a reverse proxy to route traffic between the site(s) and cloud computing environment 414. In the illustrated example, the cloud-based resource management services 402 include a client interface service 416, an identity service 418, a resource feed service 420, and a single sign-on service 422. As shown, in some embodiments, client 202 may use a resource access application 424 to communicate with client interface service 416 as well as to present a user interface on client 202 that a user 426 can operate to access resource feed(s) 406 and/or SaaS application(s) 410. Resource access application 424 may either be installed on client 202 or may be executed by client interface service 416 (or elsewhere in system 400) and accessed using a web browser (not shown in FIG. 4B) on client 202.

As explained in more detail below, in some embodiments, resource access application 424 and associated components may provide user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When resource access application 424 is launched or otherwise accessed by user 426, client interface service 416 may send a sign-on request to identity service 418. In some embodiments, identity provider 412 may be located on the premises of the organization for which system 400 is deployed. Identity provider 412 may, for example, correspond to an on-premises Windows Active Directory. In such embodiments, identity provider 412 may be connected to the cloud-based identity service 418 using a cloud connector (not shown in FIG. 4B), as described above. Upon receiving a sign-on request, identity service 418 may cause resource access application 424 (via client interface service 416) to prompt user 426 for the user's authentication credentials (e.g., username and password). Upon receiving the user's authentication credentials, client interface service 416 may pass the credentials along to identity service 418, and identity service 418 may, in turn, forward them to identity provider 412 for authentication, for example, by comparing them against an Active Directory domain. Once identity service 418 receives confirmation from identity provider 412 that the user's identity has been properly authenticated, client interface service 416 may send a request to resource feed service 420 for a list of subscribed resources for user 426.

In other embodiments (not illustrated in FIG. 4B), identity provider 412 may be a cloud-based identity service, such as a Microsoft Azure Active Directory. In such embodiments, upon receiving a sign-on request from client interface service 416, identity service 418 may, via client interface service 416, cause client 202 to be redirected to the cloud-based identity service to complete an authentication process. The cloud-based identity service may then cause client 202 to prompt user 426 to enter the user's authentication credentials. Upon determining the user's identity has been properly authenticated, the cloud-based identity service may send a message to resource access application 424 indicating the authentication attempt was successful, and resource access application 424 may then inform client interface service 416 of the successfully authentication. Once identity service 418 receives confirmation from client interface service 416 that the user's identity has been properly authenticated, client interface service 416 may send a request to resource feed service 420 for a list of subscribed resources for user 426.

For each configured resource feed, resource feed service 420 may request an identity token from single sign-on service 422. Resource feed service 420 may then pass the feed-specific identity tokens it receives to the points of authentication for the respective resource feeds 406. Each resource feed 406 may then respond with a list of resources configured for the respective identity. Resource feed service 420 may then aggregate all items from the different feeds and forward them to client interface service 416, which may cause resource access application 424 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on client 202, and/or one or more SaaS applications 410 to which user 426 has subscribed. The lists of local applications and SaaS applications 410 may, for example, be supplied by resource feeds 406 for respective services that manage which such applications are to be made available to user 426 via resource access application 424. Examples of SaaS applications 410 that may be managed and accessed as described herein include Microsoft Office 365 applications, SAP SaaS applications, Workday applications, etc.

For resources other than local applications and SaaS application(s) 410, upon user 426 selecting one of the listed available resources, resource access application 424 may cause client interface service 416 to forward a request for the specified resource to resource feed service 420. In response to receiving such a request, resource feed service 420 may request an identity token for the corresponding feed from single sign-on service 422. Resource feed service 420 may then pass the identity token received from single sign-on service 422 to client interface service 416 where a launch ticket for the resource may be generated and sent to resource access application 424. Upon receiving the launch ticket, resource access application 424 may initiate a secure session to gateway service 408 and present the launch ticket. When gateway service 408 is presented with the launch ticket, it may initiate a secure session to the appropriate resource feed and present the identity token to that feed to seamlessly authenticate user 426. Once the session initializes, client 202 may proceed to access the selected resource.

When user 426 selects a local application, resource access application 424 may cause the selected local application to launch on client 202. When user 426 selects SaaS application 410, resource access application 424 may cause client interface service 416 request a one-time uniform resource locator (URL) from gateway service 408 as well a preferred browser for use in accessing SaaS application 410. After gateway service 408 returns the one-time URL and identifies the preferred browser, client interface service 416 may pass that information along to resource access application 424. Client 202 may then launch the identified browser and initiate a connection to gateway service 408. Gateway service 408 may then request an assertion from single sign-on service 422. Upon receiving the assertion, gateway service 408 may cause the identified browser on client 202 to be redirected to the logon page for identified SaaS application 410 and present the assertion. The SaaS may then contact gateway service 408 to validate the assertion and authenticate user 426. Once the user has been authenticated, communication may occur directly between the identified browser and the selected SaaS application 410, thus allowing user 426 to use client 202 to access the selected SaaS application 410.

In some embodiments, the preferred browser identified by gateway service 408 may be a specialized browser embedded in resource access application 424 (when the resource application is installed on client 202) or provided by one of the resource feeds 406 (when resource access application 424 is located remotely), e.g., via a secure browser service. In such embodiments, SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have client interface service 416 send the link to a secure browser service, which may start a new virtual browser session with client 202, and thus allow the user to access the potentially harmful linked content in a safe environment.

In some embodiments, in addition to or in lieu of providing user 426 with a list of resources that are available to be accessed individually, as described above, user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources-SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify user 426 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for client 202. In the example shown, in addition to client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within resource access application 424 without having to launch the native application. The system shown in FIG. 4C may, for example, aggregate relevant notifications, tasks, and insights, and thereby give user 426 a dynamic productivity tool. In some embodiments, the resource activity feed may be intelligently populated by utilizing machine learning and artificial intelligence (AI) algorithms. Further, in some implementations, microapps may be configured within cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, systems of record 428 may represent the applications and/or other resources resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. Resource management services 402, and in particular data integration provider service 432, may, for example, support REST API, JSON, OData-JSON, and 6 ML. As explained in more detail below, data integration provider service 432 may also write back to the systems of record, for example, using OAuth2 or a service account.

In some embodiments, microapp service 430 may be a single-tenant service responsible for creating the microapps. Microapp service 430 may send raw events, pulled from systems of record 428, to analytics service 438 for processing. The microapp service may, for example, periodically pull active data from systems of record 428.

In some embodiments, active data cache service 436 may be single-tenant and may store all configuration information and microapp data. It may, for example, utilize a per-tenant database encryption key and per-tenant database credentials.

In some embodiments, credential wallet service 434 may store encrypted service credentials for systems of record 428 and user OAuth2 tokens.

In some embodiments, data integration provider service 432 may interact with systems of record 428 to decrypt end-user credentials and write back actions to systems of record 428 under the identity of the end-user. The write-back actions may, for example, utilize a user's actual account to ensure all actions performed are compliant with data policies of the application or other resource being interacted with.

In some embodiments, analytics service 438 may process the raw events received from microapps service 430 to create targeted scored notifications and send such notifications to notification service 440.

Finally, in some embodiments, notification service 440 may process any notifications it receives from analytics service 438. In some implementations, notification service 440 may store the notifications in a database to be later served in a notification feed. In other embodiments, notification service 440 may additionally or alternatively send the notifications out immediately to client 202 as a push notification to user 426.

In some embodiments, a process for synchronizing with systems of record 428 and generating notifications may operate as follows. Microapp service 430 may retrieve encrypted service account credentials for systems of record 428 from credential wallet service 434 and request a sync with data integration provider service 432. Data integration provider service 432 may then decrypt the service account credentials and use those credentials to retrieve data from systems of record 428. Data integration provider service 432 may then stream the retrieved data to microapp service 430. Microapp service 430 may store the received systems of record data in active data cache service 436 and also send raw events to analytics service 438. Analytics service 438 may create targeted scored notifications and send such notifications to notification service 440. Notification service 440 may store the notifications in a database to be later served in a notification feed and/or may send the notifications out immediately to client 202 as a push notification to user 426.

In some embodiments, a process for processing a user-initiated action via a microapp may operate as follows. Client 202 may receive data from microapp service 430 (via client interface service 416) to render information corresponding to the microapp. Microapp service 430 may receive data from active data cache service 436 to support that rendering. User 426 may invoke an action from the microapp, causing resource access application 424 to send that action to microapp service 430 (via client interface service 416). Microapp service 430 may then retrieve from credential wallet service 434 an encrypted Oauth2 token for the system of record for which the action is to be invoked and may send the action to data integration provider service 432 together with the encrypted Oath2 token. Data integration provider service 432 may then decrypt the Oath2 token and write the action to the appropriate system of record under the identity of user 426. Data integration provider service 432 may then read back changed data from the written-to system of record and send that changed data to microapp service 430. Microapp service 432 may then update active data cache service 436 with the updated data and cause a message to be sent to resource access application 424 (via client interface service 416) notifying user 426 that the action was successfully completed.

In some embodiments, in addition to or in lieu of the functionality described above, resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” Resource management services 402 may, for example, parse these requests and respond because they are integrated with multiple systems on the backend. In some embodiments, users may be able to interact with the virtual assistance through either resource access application 424 or directly from another resource, such as Microsoft Teams. This feature may allow employees to work efficiently, stay organized, and deliver only the specific information they're looking for.

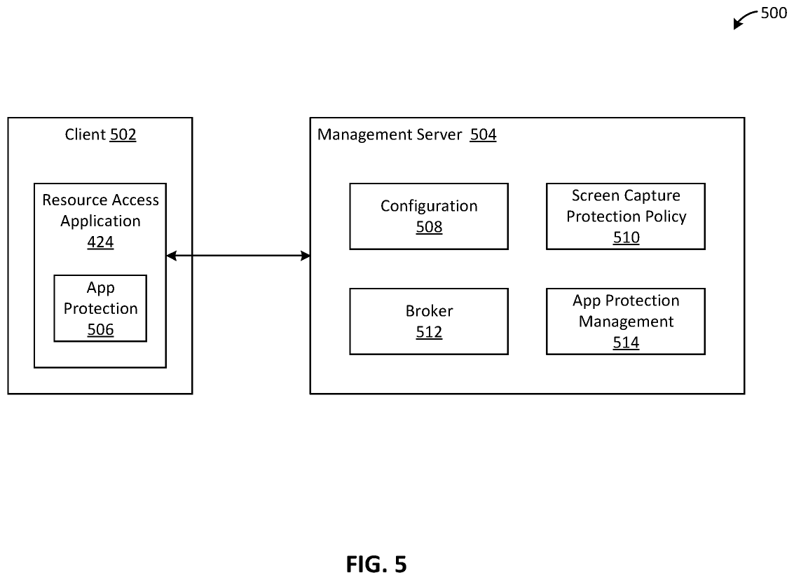

FIG. 5 is a diagram of an illustrative system 500 for selective screen capture protection on virtual desktop sessions, in accordance with an embodiment of the present disclosure. In FIG. 5, like elements of FIGS. 4A-4C are shown using like reference designators and, unless context dictates otherwise, may not be described again for purposes of clarity. As shown, illustrative system 500 includes a client 502 communicably coupled to a management server 504. Client 502 may be connected to management server 504 by one or more wired or wireless networks (not shown).

In some embodiments, system 500 may form part of a network environment, such as network environment 101 of FIG. 1. For example, client 502 of FIG. 5 may correspond to client machines 102 of FIG. 1, and management server 504 of FIG. 5 may correspond to one or more servers 106 of FIG. 1.

In some embodiments, system 500 may form part of a cloud computing environment. For example, client 502 of FIG. 5 may correspond to client machines 102 of FIG. 3, and management server 504 of FIG. 5 may correspond to a virtual or physical server providing a cloud-based service, such as DaaS 320 of FIG. 3. As another example, client 502 of FIG. 5 may correspond to clients 202 of FIGS. 4A-4C, and management server 504 of FIG. 5 may correspond to a resource management service 402 or, more particularly, to a resource feed 406 as shown and described in the context of FIGS. 4A-4C.

As shown in FIG. 5, client 502 can include resource access application 424 among various other applications. As described above, resource access application 424 and associated components installed on client 502 may provide a user of client 502 with a personalized, all-in-one interface enabling seamless access to the user's resources provided by an organization. In one example, resource access application 424 may be the CITRIX WORKSPACE app.

An application protection module 506 can be provided as a sub-module or other component of resource access application 424. Application protection module 506 and management server 504 can interoperate to provide selective screen capture protection on virtual desktop sessions. In some embodiments, the screen capture protection may be based on a determination of the type of applications running within the virtual desktop sessions and whether certain types of applications running in the virtual desktop sessions are visible on a virtual desktop session screen (sometimes referred to herein more simply as a “screen”). In some embodiments, the screen capture protection may be based on a determination of whether a screen capture and/or screen recording event on a virtual desktop session screen is being attempted/performed at the endpoints of the virtual desktop sessions. To promote clarity in the drawings, FIG. 5 shows a single resource access application 424 communicably coupled to management server 504. However, embodiments of management server 504 can be used to service many resource access applications 424 used by many different users within or otherwise associated with one or more organizations. Application protection module 506 and/or management server 504 may be implemented as computer instructions executable to perform the corresponding functions disclosed herein. Application protection module 506 and management server 504 can be logically and/or physically organized into one or more components.

Application protection module 506 can communicate with management server 504 using an API. For example, application protection module 506 can send API requests (or “messages”) or other communications to management server 504 wherein the messages/communications are received and processed by management server 504 or a component of management server 504. Likewise, management server 504 or a component of management server 504 can send API messages/communications (e.g., responses, notifications, etc.) to resource access application 424 wherein the messages/communications are received and processed by application protection module 506 or a component of resource access application 424.

In some embodiments, management server 504 is operable to provide virtual desktop access (VDA) to the organization's virtual desktops and applications. The virtual desktops and applications may be hosted in an on-premises data center of the organization, such as, for example, the data center for which system 500 is deployed, or within one or more cloud computing environments. Management server 504 can provide various VDA services including, but not limited to, user session management and resource brokering and provisioning. In the example of FIG. 5, management server 504 includes a configuration module 508, a screen capture protection policy 510, a broker module 512, and an application protection management module 514. Management server 504 can include other hardware and software resources such as those described above with respect to computing device 100 of FIG. 2.

Configuration module 508 can provide a UI, such as a graphical user interface or other user interface, by which organizations can define applications that are sensitive, and which need screen capture protection. As one example, configuration module 508 can provide a UI via which an organization can specify one or more sensitive applications that may display sensitive content which needs to be protected from being captured. Screen capture protection policy 510 can include information about the sensitive applications specified by the organization using configuration module 508. Screen capture protection policy 510 can be understood as defining the sensitive applications specified by the organization that need protection. Such applications defined by screen capture protection policy 510 are sometimes referred to herein as “protected applications.” As a result, screen capture protection policy 510 can be used to determine whether a virtual application and/or an application launched within a virtual desktop session is a protected application for which screen capture protection is to be applied.

Broker module 512 is configured to handle the various aspects of provisioning and managing VDA resources, assigning VDA resources to end users (e.g., endpoints), and updating VDA resources information to keep track of the assignments of VDA resources in a stateful manner. Such VDA resources information can include, for example, lists of VDA resources available/provisioned in the organization's data center such as a list of virtual desktops, virtual apps, and/or VMs, along with information indicating which resources are currently assigned to which end users.

Application protection management module 514 can monitor virtual desktop sessions established with endpoints and determine whether sensitive applications are running in the virtual desktop sessions. In particular, application protection management module 514 can determine whether an application running in a virtual desktop session is a sensitive application based on information contained in screen capture protection policy 510. In some embodiments, for a particular sensitive application determined to be running in a virtual desktop session, application protection management module 514 can monitor the sensitive application and determine whether the sensitive application is visible on a screen. That is, application protection management module 514 can monitor the sensitive application running within the virtual desktop session and determine whether a window (e.g., an application window) of the sensitive application is visible on the desktop screen. An application, or application window, may be considered “visible” if at least a portion of the application/window is displayed and able to be seen on the desktop screen. Various desktop environments, including virtual desktop environments, allow an application, or application window, to be “minimized” or hidden (e.g., occluded) by other windows and, thus, not able to be seen. Such running applications/windows that are minimized or hidden may be considered “not visible” for the purposes of this disclosure.

In some embodiments, application protection management module 514 can leverage functionality of or associated with a window manager to determine whether a sensitive application is visible on the screen. In some such embodiments, the window manager may be provided by the underlying OS, such as the WINDOWS, or the desktop environment. The window manager is operable to manage the placement and appearance of windows (e.g., application windows) on the screen. In more detail, the window manager can manage the creation of windows by various applications running in the virtual desktop session and which share the desktop screen. For example, in response to requests from applications to create windows, the window manager can determine the actual size and position of the windows displayed on the desktop screen, and determine which windows obscure other windows in cases where windows overlap (e.g., which windows are visible when windows overlap). The window manager can provide an interface (e.g., an API) via which information, such as the size of a window, the position of a window on the screen (e.g., screen coordinates), and whether a window (e.g., an application) is visible or not visible, among other information, may be obtained. In other embodiments, application protection management module 514 can utilize one or more functions provided by the underlying OS, such as the EnumWindows function, GetWindowRec function, GetWindow function, and/or GetDesktopWindow function provided by WINDOWS, to determine whether a sensitive application is visible on the screen and, if so, information about the visible sensitive application such as the position of the visible window of the sensitive application on the screen (e.g., screen coordinates). In any case, upon determining that a sensitive application (i.e., a protected application) running within a virtual desktop session is visible on the screen, application protection management module 514 can send an enable notification to the endpoint of or associated with the virtual desktop session that causes the endpoint to enable screen capture protection on the virtual desktop session at the endpoint. Enabling screen capture protection on the virtual desktop session prevents the desktop screen from being captured (e.g., screen captured) at the endpoint.

In some embodiments, application protection management module 514 can include sensitive region information with an enable notification to an endpoint of a virtual desktop session that causes the endpoint to enable a region-based screen capture protection at the endpoint. The sensitive region information, such as the screen coordinates, can define the region of the screen in which a sensitive application running in the virtual desktop session is visible. In other words, sensitive region information defines the region of the desktop screen in which the window or a portion of the window of the sensitive application is visible. Such regions of the desktop screen are sometimes referred to herein as “protected regions.” The sensitive region information can be used to provide region-based screen capture protection on the virtual desktop session. For example, based on the sensitive region information, the endpoint can enable region-based screen capture protection that prevents the protected region of the desktop screen (e.g., the region of the screen defined by the screen coordinates) from being captured at the endpoint. Note that with region-based screen capture protection, the regions of the screen outside the protected region(s) can be captured (e.g., screen captured) at the endpoint. That is, with region-based screen capture protection, the regions of the screen outside the protected region(s) are not protected from being screen captured and shared, for example.

In response to sending an enable notification to an endpoint to enable screen capture protection, according to some embodiments, application protection management module 514 can monitor the virtual desktop session with the endpoint to determine whether any sensitive applications running in the virtual desktop session is visible on the screen. For example, for a particular virtual desktop session, application protection management module 514 can monitor the virtual desktop session to determine whether any of the protected applications which were visible on the screen and which caused the enabling of the screen capture protection at the endpoint are still visible on the screen. Upon determining that no sensitive application running in the virtual desktop session is visible on the screen (e.g., all sensitive applications running in the virtual desktop session are minimized and/or closed), application protection management module 514 can send a disable notification to the endpoint of the virtual desktop session that causes the endpoint to disable screen capture protection on the virtual desktop session at the endpoint. Disabling screen capture protection on the virtual desktop session no longer prevents the desktop screen from being captured (e.g., screen captured) at the endpoint (e.g., removes the previously enabled screen capture protection on the virtual desktop session and, as a result, no longer prevents the desktop screen from being captured).

In some embodiments, application protection management module 514 can include information identifying the sensitive application that is no longer visible with a disable notification to an endpoint of a virtual desktop session that causes the endpoint to disable the screen capture protection on the virtual desktop session at the endpoint. For example, upon determining that a particular sensitive application that was previously visible on the screen is no longer visible on the screen (e.g., the sensitive application running in the desktop session is minimized and/or closed), application protection management module 514 can include information identifying the sensitive application that is no longer visible along with the disable notification to the endpoint of the virtual desktop session. In response, the endpoint can use the information identifying the sensitive application to disable the screen capture protection on the virtual desktop session that was previously enabled as the result of the sensitive application being previously visible on the screen.

In some embodiments, application protection management module 514 can include information about a protected region with a disable notification to an endpoint of a virtual desktop session that causes the endpoint to disable the region-based screen capture protection at the endpoint. For example, upon determining that a particular sensitive application that was previously visible on the screen is no longer visible on the screen, application protection management module 514 can include information about the protected region associated with the sensitive application that is no longer visible (e.g., the screen coordinates defining the region of the screen in which the sensitive application was previously visible) along with the disable notification to the endpoint of the virtual desktop session. In response, the endpoint can use the information about the protected region to disable the region-based screen capture protection that was previously enabled as the result of the sensitive application being previously visible in that region of the screen. Disabling region-based screen capture protection for a protected region of the screen no longer prevents that region of the desktop screen from being captured (e.g., screen captured) at the endpoint (e.g., removes the previously enabled region-based screen capture protection on the virtual desktop session for that particular region of the screen and, as a result, no longer prevents that region of the desktop screen from being captured).

In some embodiments, application protection management module 514 can monitor virtual desktop sessions established with endpoints for resumption of the virtual desktop sessions. For example, a user may use client 502 to resume a previous (e.g., idle) virtual desktop session that the user previously started but was disconnected. In some embodiments, for a particular previous virtual desktop session established with an endpoint, application protection management module 514 can monitor for reconnect and resume of the virtual desktop session. Upon detecting a reconnect of the virtual desktop session, application protection management module 514 can determine whether any sensitive applications are running in the reconnected virtual desktop session and, if there are any sensitive applications running in the reconnected virtual desktop session, determine whether any of the sensitive applications are visible on the screen. If application protection management module 514 determines that a sensitive application running within the reconnected virtual desktop session is visible on the screen, application protection management module 514 can send an enable notification to the endpoint of the reconnected virtual desktop session that causes the endpoint to enable screen capture protection on the reconnected virtual desktop session at the endpoint. In some embodiments, application protection management module 514 can include sensitive region information with the enable notification to the endpoint of the reconnected virtual desktop session that causes the endpoint to enable a region-based screen capture protection on the reconnected virtual desktop session at the endpoint. The sensitive region information (e.g., screen coordinates) defines the region or regions of the screen in which the sensitive application or sensitive applications running in the reconnected virtual desktop session are visible.

In some embodiments, application protection management module 514 can enable screen capture protection on sensitive applications running within a virtual desktop session. For example, for a particular virtual desktop session established with an endpoint, application protection management module 514 can determine whether a screen capture and/or screen recording event on the virtual desktop session screen is being performed at the endpoint. For example, in response to detecting a launch of a screen capture/screen recording event on the virtual desktop session screen at the endpoint, the endpoint can send a notification to application protection management module 514 informing of the launch of the screen capture/screen recording event on the virtual desktop session screen at the endpoint. In response, application protection management module 514 can enable screen capture protection on the sensitive applications running within the virtual desktop session. Application protection management module 514 can use screen capture protection policy 514 to determine which of the applications running in the virtual desktop session are sensitive applications. In some embodiments, application protection management module 514 can utilize (e.g., invoke) a function provided by the underlying OS, such as the SetWindowDisplay Affinity function provided by WINDOWS, to enable screen capture protection on the sensitive applications running in the virtual desktop session. For example, application protection management module 514 can invoke the SetWindowDisplayAffinity function on the individual sensitive application processes. The SetWindowDisplayAffinity function protects the contents of the window of the sensitive application, as well as contents of newly created windows of the sensitive application, from being screen captured or recorded. In one example, application protection management module 514 can enable the screen capture protection on the sensitive applications thus causing the sensitive applications to be displayed greyed or blacked out or otherwise not visible on the screen. As a result, the sensitive application windows will appear greyed or blacked out in the screen capture image.

In some embodiments, application protection management module 514 can disable screen capture protection enabled for sensitive applications running within a virtual desktop session. For example, for a particular virtual desktop session established with an endpoint, application protection management module 514 can determine whether a screen capture and/or screen recording event on the virtual desktop session screen that is launched or being performed at the endpoint is completed. For example, in response to determining that a screen capture/screen recording event launched on the virtual desktop session screen at the endpoint is complete, the endpoint can send a notification to application protection management module 514 informing of the completion of the screen capture/screen recording event on the virtual desktop session screen at the endpoint. In response to such notification, application protection management module 514 can disable the currently activated screen capture protection on the sensitive applications running within the virtual desktop session. In some embodiments, application protection management module 514 can maintain a list of the sensitive applications running within the virtual desktop session and for which screen capture protection is enabled. For example, according to one embodiment, application protection management module 514 can disable the screen capture protection by undoing or “reversing” the operations previously performed to enable the screen capture protection on the sensitive applications running in the virtual desktop session. For instance, in the case where the SetWindowDisplayAffinity function is utilized to enable screen capture protection on the sensitive applications running in the virtual desktop session, application protection management module 514 can utilize the SetWindowDisplayAffinity function to disable the screen capture protection on the sensitive applications. Disabling screen capture protection on the sensitive applications may no longer cause the sensitive applications to be displayed greyed or blacked out or otherwise not visible on the screen. In other words, disabling screen capture protection on the sensitive applications may cause the sensitive applications to be visible on the screen.

Referring to client 502, application protection module 506 is operable to enable and disable screen capture protection on virtual desktop sessions. In the case where client 502 is a virtual desktop endpoint of a virtual desktop session hosted by management server 504, application protection module 506 may receive an enable notification to enable screen capture protection on the virtual desktop session. For example, a user a user may use client 502 as an endpoint device to access management server 504 and establish a virtual desktop session. As previously described, application protection management module 514 of management server 504 may send an enable notification to enable screen capture protection on the virtual desktop session upon determining that a sensitive application in the virtual desktop session is visible on a screen. In response to receiving such enable notification, application protection module 506 can enable screen capture protection on the virtual desktop session at client 502 (e.g., enable screen capture protection on the virtual desktop session at the endpoint of the virtual desktop session). In some embodiments, application protection module 506 can utilize a function provided by the underlying OS, such as the SetWindowDisplay Affinity function provided by WINDOWS, to enable screen capture protection on the virtual desktop session. For example, application protection module 506 can invoke the Set WindowDisplay Affinity function on the virtual desktop session process. Once the SetWindowDisplayAffinity function is called on the process, all windows belonging to the process and newly created windows on the process are protected from screen capture and screen recording. As a result, all windows belonging to the virtual desktop session and newly created windows in the virtual desktop session are protected from screen capture and screen recording. Once the screen capture protection is enabled in this manner, application protection module 506 can, according to one embodiment, hook into the Set WindowDisplay Affinity API to intercept calls to the SetWindow Display Affinity function. By hooking the SetWindowDisplay Affinity API, application protection module 506 can prevent the reuse of the SetWindowDisplay Affinity function by another process/application to remove (e.g., disable) the screen capture protection on the virtual desktop session.

Additionally or alternatively, application protection module 506 can generate hook procedures (e.g., an operating system API hooks) to monitor for and intercept API calls related to screen capture and/or screen recording on client 502. Non-limiting examples of APIs related to screen capture and/or screen recording include graphics device interface (GDI) APIs such as BitBlt, GdiTransparentBlt, MastBlt, PlgBlt, StretchBlt, and TransparentBlt, DirectX9 APIs such as IDirect3DDevice9::GetFrontBufferData and IDirect3DSwapChain9::GetFrontBufferData, DXGI APIs such as IDXGIOutput::GetDisplaySurfaceData, IDXGIOutput1::GetDisplaySurfaceData1, and IDXGIOutputDuplication::AcquireNextFrame, Magnification APIs such as MagSetWindowFilterList and MagSetWindowSource, Print APIs such as PrintWindow, desktop window manager APIs such as DwmRegisterThumbnail, digital rights management APIs such as DRMIsWindowProtected, and synthetic keystroke generation APIs such as keybd_event and SendInput. Creating such hook procedures allows application protection module 506 to determine whether an application or process may be attempting a screen capture and/or screen recording on client 502 using the hooked APIs. Application protection module 506 can use the created hook procedures to provide screen capture protection on the virtual desktop session. In some embodiments, the organization may generate a whitelist which defines one or more APIs to exclude from the API hooking. Using the whitelist, the organization is able to identify and exclude certain APIs related to screen capture and/or screen recording from being hooked, for example, by application protection module 506. For example, the organization may determine that use of the APIs included in the whitelist are permitted even though screen capture protection is enabled on the virtual desktop session.

In some embodiments, application protection module 506 can utilize one or more DirectX APIs, provided by Microsoft Corporation, to enable screen capture protection on the virtual desktop session. In such embodiments, application protection module 506 can use the DirectX APIs to modify swap chain attributes to define rendering characteristics, such as the size of the render area, the display mode, and the surface format, to provide screen capture protection on the virtual desktop session.

In some embodiments, application protection module 506 can enable region-based screen capture protection on a virtual desktop session at client 502. For example, application protection management module 514 of management server 504 may send an enable notification that includes sensitive region information defining a protected region of the screen to enable region-based screen capture protection on upon determining that a sensitive application in a virtual desktop session is visible on a screen. In response, application protection module 506 can enable region-based screen capture protection on the virtual desktop session at client 502 based on the sensitive region information included or otherwise provided with the enable notification, which prevents the protected region of the desktop screen from being captured at client 502. For example, in some embodiments, application protection module 506 can utilize one or more DirectX APIs, provided by Microsoft Corporation, to enable region-based screen capture protection on the virtual desktop session (e.g., modify swap chain attributes to define rendering characteristics to provide region-based screen capture protection on the virtual desktop session).

In some embodiments, application protection module 506 can disable screen capture protection on a virtual desktop session at client 502. The disabling may be of either screen capture protection or region-based screen capture protection on a virtual desktop session. For example, application protection management module 514 of management server 504 may send a disable notification to disable screen capture protection on a virtual desktop session upon determining that no sensitive application running in the virtual desktop session is visible on the screen. Similarly, application protection management module 514 of management server 504 may send a disable notification that includes information about one or more protected regions to disable region-based screen capture protection on upon determining that sensitive applications associated with the one or more protected regions are no longer visible on the screen. In any case, in response to receiving such disable notification, application protection module 506 can disable screen capture protection or region-based screen capture protection on the virtual desktop session at client 502. For example, according to one embodiment, application protection module 506 can disable the screen capture protection by undoing or “reversing” the operations previously performed to enable the screen capture protection. For instance, in the case where the SetWindowDisplayAffinity function is utilized to enable screen capture protection, application protection module 506 can utilize the SetWindowDisplayAffinity function to disable screen capture protection. As another example, in the case where API hooks are used to enable screen capture protection, application protection module 506 can undo the API hooks to disable screen capture protection.

In the embodiment of FIG. 5, application protection module 506 is shown as a component of resource access application 424. In other embodiments, application protection module 506 may be implemented as a plug-in or extension to another application on client 502, such as, for example, a web browser.

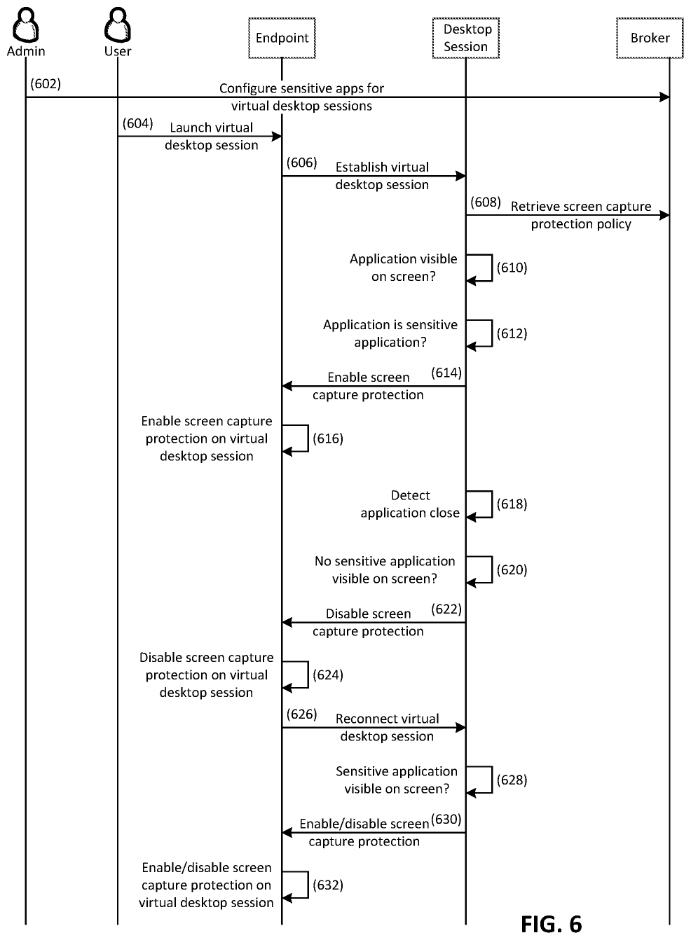

FIG. 6 is a sequence diagram showing an example flow of interactions between various components to provide selective screen capture protection, in accordance with an embodiment of the present disclosure. In the example of FIG. 6, the interactions may be between various components of system 500 of FIG. 5 to provide selective screen capture protection on a virtual desktop session.

An administrator within or otherwise associated with an organization may configure (602) sensitive applications for virtual desktop sessions. The configured sensitive applications can be understood to be the applications (e.g., application processes) that are to be treated as sensitive by the organization and whose contents are to be protected from being captured (e.g., protected from being screen captured or screen recorded). The individual sensitive applications may be uniquely identified using attributes such as, for example, a binary path, a digital signature, a version, or similar attributes. Identifying the sensitive applications in such manner allows for identifying or otherwise locating the sensitive applications at endpoints of virtual desktop sessions. In some embodiments, the sensitive applications may be defined using a screen capture protection policy (e.g., screen capture protection policy 514 of FIG. 5) on a broker configured to handle aspects of provisioning and managing VDA sessions (e.g., broker module 512 of FIG. 5).

A user within or otherwise associated with the organization may use a resource access application on an endpoint device (e.g., resource access application 424 on client 502 of FIG. 5) to launch (604) a virtual desktop session. In response, the endpoint may establish (606) a virtual desktop session with a host configured to provide VDA to the organization's virtual desktops and applications (e.g., management server 504 of FIG. 5). When the virtual desktop session is established by the endpoint, the desktop session may retrieve and apply (608) the screen capture protection policy from the broker. As mentioned previously, the screen capture protection policy can contain a list of sensitive applications that are to be protected from screen capture. The desktop session may then monitor for launches and closures of applications within the virtual desktop session (e.g., monitor for application window open and minimize events).

In the example of FIG. 6, the desktop session may determine (610) that an application running in the virtual desktop session is visible on a screen. For example, the user may access the application via their virtual desktop. The desktop session may leverage functionality of a window manager to determine that the application running in the virtual desktop session is visible on the screen. In response, the desktop session may check (612) to determine whether the application running in the virtual desktop session, and which is visible on the screen is a sensitive application that is to be protected from screen capture. For example, the virtual desktop session may make this determination based on the applied screen capture protection policy. In one embodiment, the operations at 610 and 612 may be performed in reverse order (e.g., operations at 612 followed by operations at 610).

If the determination at (612) is that the application running in the virtual desktop session, and which is visible on the screen is a sensitive application, the desktop session may enable screen capture protection on the virtual desktop session. To do so, the desktop session may send (614) an enable notification to the endpoint of the virtual desktop session that causes the endpoint to enable screen capture protection on the virtual desktop session. The enable notification may be an instruction to enable the screen capture protection on the virtual desktop session. In response to the enable notification, the endpoint may enable (616) screen capture protection on the virtual desktop session. For example, the resource access application on the endpoint may receive the enable notification and pass the enable notification to an application protection component on the endpoint (e.g., application protection module 506 of FIG. 5) for processing. In response to the enable notification, the application protection component may enable screen capture protection on the virtual desktop session at the endpoint. For example, the application protection component may utilize a function provided by the underlying OS to enable the screen capture protection on the virtual desktop session.

Continuing the example of FIG. 6, the desktop session may detect (618) an application close event in the virtual desktop session (e.g., detect the closing or minimizing of an application running in the virtual desktop session). In response, the desktop session may check (620) to determine whether no sensitive application running in the virtual desktop session is visible on the screen. If the determination at (620) is that no sensitive application running in the virtual desktop session is visible on the screen, the desktop session may disable screen capture protection on the virtual desktop session. Here, since no sensitive application is visible on the screen, screen capture may be performed at the endpoint. To disable the screen capture protection on the virtual desktop session, the desktop session may send (622) a disable notification to the endpoint of the virtual desktop session that causes the endpoint to disable screen capture protection on the virtual desktop session. The disable notification may be an instruction to disable the previously enabled screen capture protection on the virtual desktop session.

In response to the disable notification, the endpoint may disable (624) the screen capture protection on the virtual desktop session. For example, the resource access application on the endpoint may receive the disable notification and pass the disable notification to the application protection component on the endpoint (e.g., application protection module 506 of FIG. 5) for processing. In response to the disable notification, the application protection component may disable the screen capture protection on the virtual desktop session at the endpoint. For example, the application protection component may utilize a function provided by the underlying OS to disable the screen capture protection on the virtual desktop session.

The endpoint may reconnect (626) the virtual desktop session with the host. For example, the virtual desktop session established at 606 may have been disconnected for any of a variety of causes. Subsequent to the disconnection of the virtual desktop session, the user may use the endpoint to reconnect and resume the virtual desktop session. Upon reconnect of the virtual desktop session, the desktop session may check (628) to determine whether any sensitive application running in the reconnected virtual desktop session is visible on the screen. Here, if any visible application running in the reconnected virtual desktop session is visible on the screen, screen capture protection on the virtual desktop session needs to be enabled (e.g., screen capture protection needs to be applied to the reconnected virtual desktop session). Conversely, if no sensitive application running in the reconnected virtual desktop session is visible on the screen, screen capture protection on the reconnected virtual desktop session can be disabled (e.g., screen capture protection is not needed on the reconnected virtual desktop session).

If the determination at (628) is that a sensitive application running in the reconnected virtual desktop session is visible on the screen, the desktop session may enable screen capture protection on the reconnected virtual desktop session. To do so, the desktop session may send (630) an enable notification to the endpoint of the reconnected virtual desktop session that causes the endpoint to enable screen capture protection on the reconnected virtual desktop session. Conversely, if the determination at (628) is that no sensitive application running in the virtual desktop session is visible on the screen (e.g., sensitive applications running in the virtual desktop session are not visible on the screen), the desktop session may disable screen capture protection on the reconnected virtual desktop session. To disable the screen capture protection on the reconnected virtual desktop session, the desktop session may send (630) a disable notification to the endpoint of the reconnected virtual desktop session that causes the endpoint to disable screen capture protection on the reconnected virtual desktop session.

In response to the enable notification, the endpoint may enable (632) screen capture protection on the reconnected virtual desktop session at the endpoint. In response to the disable notification, the endpoint may disable (632) the screen capture protection on the reconnected virtual desktop session.

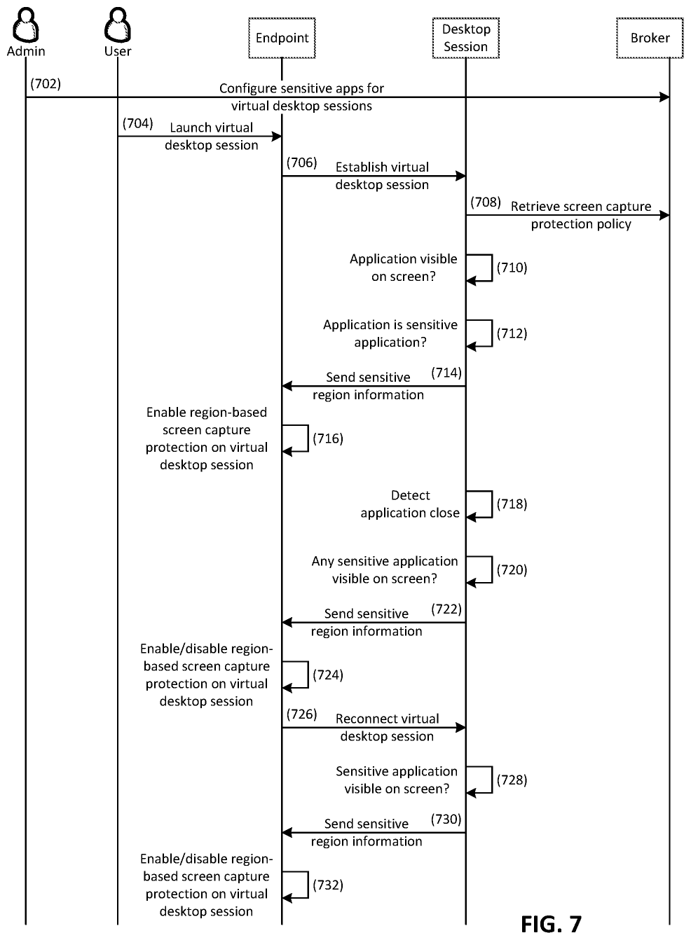

FIG. 7 is a sequence diagram showing an example flow of interactions between various components to provide selective region-based screen capture protection, in accordance with an embodiment of the present disclosure. In the example of FIG. 7, the interactions may be between various components of system 500 of FIG. 5 to provide selective region-based screen capture protection on a virtual desktop session.

An administrator associated with an organization may configure (702) sensitive applications for virtual desktop sessions. The configured sensitive applications can be understood to be the applications (e.g., application processes) that are to be treated as sensitive by the organization and whose contents are to be protected from being captured (e.g., protected from being screen captured or screen recorded). The individual sensitive applications may be uniquely identified using attributes such as, for example, a binary path, a digital signature, a version, or similar attributes. Identifying the sensitive applications in such manner allows for identifying or otherwise locating the sensitive applications at endpoints of virtual desktop sessions. In some embodiments, the sensitive applications may be defined using a screen capture protection policy (e.g., screen capture protection policy 514 of FIG. 5) on a broker configured to handle aspects of provisioning and managing VDA sessions (e.g., broker module 512 of FIG. 5).

A user associated with the organization may use a resource access application on an endpoint device (e.g., resource access application 424 on client 502 of FIG. 5) to launch (704) a virtual desktop session. In response, the endpoint may establish (706) a virtual desktop session with a host configured to provide VDA to the organization's virtual desktops and applications (e.g., management server 504 of FIG. 5). When the virtual desktop session is established by the endpoint, the desktop session may retrieve and apply (708) the screen capture protection policy from the broker. As mentioned previously, the screen capture protection policy can contain a list of sensitive applications that are to be protected from screen capture. The desktop session may then monitor for launches and closures of applications within the virtual desktop session (e.g., monitor for application window open and minimize events).

In the example of FIG. 7, the desktop session may determine (710) that an application running in the virtual desktop session is visible on a screen. For example, the user may access the application via their virtual desktop. The desktop session may leverage functionality of a window manager to determine that the application running in the virtual desktop session is visible on the screen. In response, the desktop session may check (712) to determine whether the application running in the virtual desktop session, and which is visible on the screen is a sensitive application that is to be protected from screen capture. For example, the virtual desktop session may make this determination based on the applied screen capture protection policy. In one embodiment, the operations at 710 and 712 may be performed in reverse order (e.g., operations at 712 followed by operations at 710).

If the determination at (712) is that the application running in the virtual desktop session, and which is visible on the screen is a sensitive application, the desktop session may enable region-based screen capture protection on the virtual desktop session. To do so, the desktop session may send (714) an enable notification along with sensitive region information to the endpoint of the virtual desktop session that causes the endpoint to enable region-based screen capture protection on the virtual desktop session. The sensitive region information, such as the screen coordinates, defines the region of the screen in which the sensitive application running in the virtual desktop session is visible. The sensitive region information included with the enable notification may be an instruction to enable the region-based screen capture protection on the virtual desktop session.

In response to the enable notification and the included sensitive region information, the endpoint may enable (716) region-based screen capture protection on the virtual desktop session. For example, the resource access application on the endpoint may receive the enable notification including the sensitive region information, and pass the enable notification including the sensitive region information to an application protection component on the endpoint (e.g., application protection module 506 of FIG. 5) for processing. In response, the application protection component may enable region-based screen capture protection on the virtual desktop session at the endpoint. For example, the application protection component may utilize DirectX APIs, provided by Microsoft Corporation, to enable region-based screen capture protection on the virtual desktop session. As a result of the enabled region-based screen capture protection, the region of the screen defined by the sensitive region information (i.e., the region of the screen in which the sensitive application running in the virtual desktop session is visible) is protected from being captured at the endpoint. That is, the screen capture protection is on the region of the screen in which the sensitive application running in the virtual desktop session is visible. The regions of the screen outside the region protected by the region-based screen capture protection are not protected from screen capture (e.g., screen capture can be performed on the regions of the screen outside of the protected region). Note that there may be one or more regions of the screen that are protected from being captured at the endpoint. For example, one or more regions of a window of a sensitive application running in the virtual desktop session may be visible on the screen. As another example, one or more sensitive applications running in the virtual desktop session may be visible on the screen. In any case, region-based screen capture protection may be enabled for the one or more regions of the screen.

In some embodiments, if the sensitive application running in the virtual desktop session and which is visible on the screen is resized (e.g., the sensitive application is visible in a another or updated region of the screen), the desktop session may send an enable notification along with sensitive region information that defines the updated region of the screen in which the resized sensitive application running in the virtual desktop session is visible. In response, the endpoint may enable region-based screen capture protection which protects the updated region of the screen from being captured. In such cases, the endpoint may disable the region-based screen capture protection that was enabled for the region (e.g., old region) of the screen in which the sensitive application was previously visible prior to the resizing.

Continuing the example of FIG. 7, the desktop session may detect (718) an application close event in the virtual desktop session (e.g., detect the closing or minimizing of an application running in the virtual desktop session). In response, the desktop session may check (720) to determine whether any sensitive application running in the virtual desktop session is visible on the screen. If the determination at (720) is that there is a sensitive application running in the virtual desktop session that is visible on the screen, the desktop session may send (722) an enable notification along with sensitive region information to the endpoint of the virtual desktop session. Note that there may be one or more sensitive applications running in the virtual desktop session that are visible on the screen. In such cases, the sensitive region information may define the regions of the screen in which the one or more sensitive applications running in the virtual desktop session are visible. In response, the endpoint may enable (724) region-based screen capture protection that protects the regions of the screen defined by the sensitive region information from being captured at the endpoint.

If the determination at (720) is that no sensitive application running in the virtual desktop session is visible on the screen, the desktop session may send a disable notification along with information about one or more protected regions to disable region-based screen capture protection on. The one or more protected regions may be regions of the screen in which sensitive applications running or previously running in the virtual desktop session were visible and are currently protected from being captured. In response, the endpoint may disable the region-based screen capture protection which was enabled on the protected regions. As a result, no region of the screen is protected from being captured at the endpoint since no sensitive application running in the virtual desktop session is visible on the screen.

The endpoint may reconnect (726) the virtual desktop session with the host. For example, the virtual desktop session established at 706 may have been disconnected for any of a variety of causes. Subsequent to the disconnection of the virtual desktop session, the user may use the endpoint to reconnect and resume the virtual desktop session. Upon reconnect of the virtual desktop session, the desktop session may check (728) to determine whether any sensitive application running in the reconnected virtual desktop session is visible on the screen. Here, if any visible application running in the reconnected virtual desktop session is visible on the screen, region-based screen capture protection on the reconnected virtual desktop session needs to be enabled (e.g., screen capture protection needs to be applied to the regions of the screen in which sensitive applications running in the reconnected virtual desktop session are visible). Conversely, if no sensitive application running in the reconnected virtual desktop session is visible on the screen, any region-based screen capture protection that may exist can be disabled.

If the determination at (728) is that there is a sensitive application running in the reconnected virtual desktop session that is visible on the screen, the desktop session may send (730) an enable notification along with sensitive region information to the endpoint of the reconnected virtual desktop session. As noted previously, there may be one or more sensitive applications running in the reconnected virtual desktop session that are visible on the screen. In such cases, the sensitive region information may define the regions of the screen in which the one or more sensitive applications running in the reconnected virtual desktop session are visible. In response, the endpoint may enable (732) region-based screen capture protection that protects the regions of the screen defined by the sensitive region information from being captured at the endpoint.

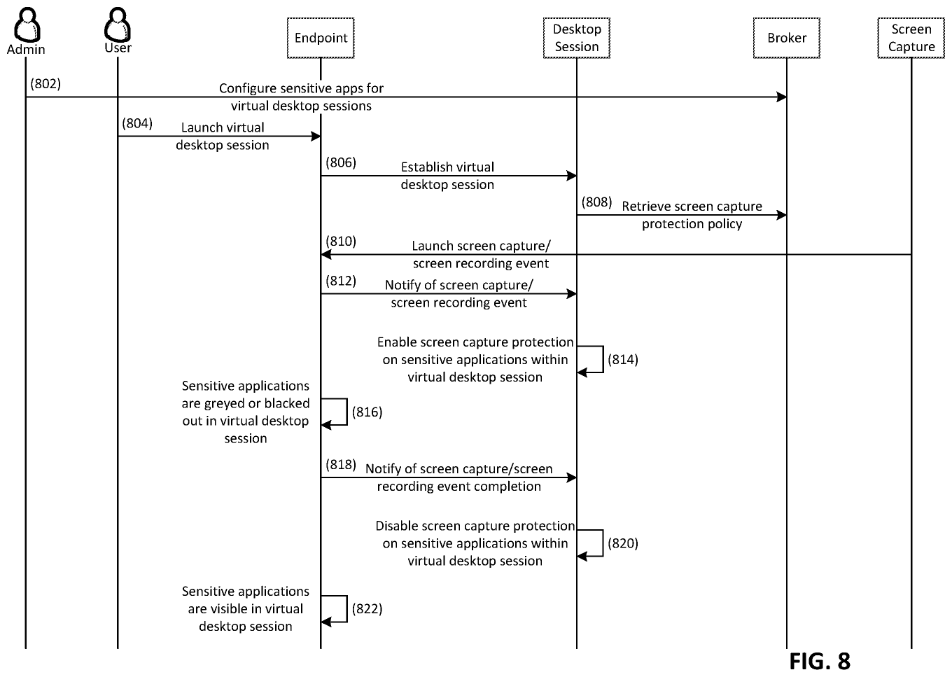

FIG. 8 is a sequence diagram showing an example flow of interactions between various components to enforce screen capture protection for a sensitive application running within a virtual desktop session, in accordance with an embodiment of the present disclosure. In the example of FIG. 8, the interactions may be between various components of system 500 of FIG. 5 to enforce screen capture protection for a sensitive application running within a virtual desktop session.

An administrator associated with an organization may configure (802) sensitive applications for virtual desktop sessions. The configured sensitive applications can be understood to be the applications (e.g., application processes) that are to be treated as sensitive by the organization and whose contents are to be protected from being captured (e.g., protected from being screen captured or screen recorded). In some embodiments, the sensitive applications may be defined using a screen capture protection policy (e.g., screen capture protection policy 514 of FIG. 5) on a broker configured to handle aspects of provisioning and managing VDA sessions (e.g., broker module 512 of FIG. 5).

A user associated with the organization may use a resource access application on an endpoint device (e.g., resource access application 424 on client 502 of FIG. 5) to launch (804) a virtual desktop session. In response, the endpoint may establish (806) a virtual desktop session with a host configured to provide VDA to the organization's virtual desktops and applications (e.g., management server 504 of FIG. 5). When the virtual desktop session is established by the endpoint, the desktop session may retrieve and apply (808) the screen capture protection policy from the broker. As mentioned previously, the screen capture protection policy can contain a list of sensitive applications that are to be protected from screen capture.

The endpoint may detect (810) a launch of a screen capture/screen recording event on the virtual desktop session screen. For example, the user may use the endpoint device and initiate a screen capture of the virtual desktop session screen at the endpoint. As another example, a malicious actor may cause a process on the endpoint device to attempt a screen capture/screen recording of the virtual desktop session screen. In any case, the endpoint may be configured to detect a launch of a screen capture/screen recording event on the virtual desktop session screen. For example, the endpoint may utilize API hooking mechanisms (e.g., generate hooks on OS API calls related to screen capture and/or screen recording) to detect a launch of screen capture/screen recording event at the endpoint.

In response to detecting the launch of the screen capture/screen recording event on the virtual desktop session screen, the endpoint may send (812) a notification to the desktop session informing of the screen capture/screen recording event on the virtual desktop session screen. In response, the desktop session may enable (814) screen capture protection on the sensitive applications running within the virtual desktop session. For example, the desktop session may utilize a function provided by the underlying OS (e.g., the SetWindowDisplay Affinity function provided by WINDOWS) to enable screen capture protection on the sensitive applications. The desktop session may determine whether an application running in the virtual desktop session is a sensitive application based on the applied screen capture protection policy. The enabled screen capture protection causes (816) the sensitive applications running in the virtual desktop session to be displayed greyed or blacked out on the virtual desktop session screen.

Subsequently, the endpoint may send (818) a notification to the desktop session informing of the completion of the screen capture/screen recording event on the virtual desktop session screen. For example, upon detecting a launch of a screen capture/screen recording event, the endpoint can monitor for completion of the screen capture/screen recording event. In response to the notification from the endpoint, the desktop session may disable (820) the screen capture protection that was enabled on the sensitive applications running in the virtual desktop session. For example, the desktop session may undo or reverse the operations previously performed to enable the screen capture protection to disable the screen capture protection on the sensitive applications running in the virtual desktop session. Disabling the screen capture protection causes (822) the sensitive applications running in the virtual desktop session to be visible on the virtual desktop session screen.

### FURTHER EXAMPLE EMBODIMENTS

The following examples pertain to further embodiments, from which numerous permutations and configurations will be apparent.

Example 1 includes a method including: establishing, by a computing device, a virtual desktop session with an endpoint; retrieving, by the computing device, a screen capture protection policy defining one or more sensitive applications for screen capture protection; and, responsive to a determination that a sensitive application is visible on a screen, enabling, by the computing device, screen capture protection on the virtual desktop session, wherein the determination that the sensitive application is visible is based on the screen capture protection policy.

Example 2 includes the subject matter of Example 1, wherein enabling the screen capture protection includes sending an enable notification to the endpoint to enable the screen capture protection at the endpoint, so as to prevent screen capture of the screen at the endpoint.

Example 3 includes the subject matter of Example 1, wherein enabling the screen capture protection includes sending an enable notification with sensitive region information to the endpoint to enable a region-based screen capture protection at the endpoint, so as to prevent screen capture of a region of the screen at the endpoint, wherein the region of the screen is determined from the sensitive region information.

Example 4 includes the subject matter of any of Examples 1 through 3, further including, responsive to a determination that no sensitive application is visible on the screen, disabling, by the computing device, screen capture protection on the virtual desktop session.

Example 5 includes the subject matter of Example 4, wherein disabling the screen capture protection includes sending a disable notification to the endpoint to disable the screen capture protection at the endpoint.

Example 6 includes the subject matter of Example 4, wherein disabling the screen capture protection includes sending a disable notification to the endpoint to disable a region-based screen capture protection at the endpoint.

Example 7 includes the subject matter of any of Examples 1 through 6, further including, responsive to a reconnect of the virtual desktop session, by the computing device: responsive to a determination that at least one sensitive application is visible on a screen, enabling screen capture protection on the virtual desktop session, wherein the determination that the at least one sensitive application is visible is based on the screen capture protection policy.

Example 8 includes a computing device including a processor and a non-volatile memory storing computer program code that when executed on the processor causes the processor to execute a process. The process includes: establishing a virtual desktop session with an endpoint; retrieving a screen capture protection policy defining one or more sensitive applications for screen capture protection; and, responsive to a determination that a sensitive application is visible on a screen, enabling screen capture protection on the virtual desktop session, wherein the determination that the sensitive application is visible is based on the screen capture protection policy.

Example 9 includes the subject matter of Example 8, wherein enabling the screen capture protection includes sending an enable notification to the endpoint to enable the screen capture protection at the endpoint, so as to prevent screen capture of the screen at the endpoint.

Example 10 includes the subject matter of Example 8, wherein enabling the screen capture protection includes sending an enable notification with sensitive region information to the endpoint to enable a region-based screen capture protection at the endpoint, so as to prevent screen capture of a region of the screen at the endpoint, wherein the region of the screen is determined from the sensitive region information.

Example 11 includes the subject matter of any of Examples 8 through 10, wherein the process further includes, responsive to a determination that no sensitive application is visible on the screen, disabling screen capture protection on the virtual desktop session.

Example 12 includes the subject matter of Example 11, wherein disabling the screen capture protection includes sending a disable notification to the endpoint to disable the screen capture protection at the endpoint.

Example 13 includes the subject matter of Example 11, wherein disabling the screen capture protection includes sending a disable notification to the endpoint to disable a region-based screen capture protection at the endpoint.

Example 14 includes the subject matter of any of Examples 8 through 13, wherein the process also includes, responsive to a reconnect of the virtual desktop session: responsive to a determination that at least one sensitive application is visible on a screen, enabling screen capture protection on the virtual desktop session, wherein the determination that the at least one sensitive application is visible is based on the screen capture protection policy.

Example 15 includes a non-transitory machine-readable medium encoding instructions that when executed by one or more processors cause a process to be carried out. The process includes: establishing a virtual desktop session with an endpoint; retrieving a screen capture protection policy defining one or more sensitive applications for screen capture protection; and, responsive to a determination that a sensitive application is visible on a screen, enabling screen capture protection on the virtual desktop session, wherein the determination that the sensitive application is visible is based on the screen capture protection policy.

Example 16 includes the subject matter of Example 15, wherein enabling the screen capture protection includes sending an enable notification to the endpoint to enable the screen capture protection at the endpoint, so as to prevent screen capture of the screen at the endpoint.

Example 17 includes the subject matter of Example 15, wherein enabling the screen capture protection includes sending an enable notification with sensitive region information to the endpoint to enable a region-based screen capture protection at the endpoint, so as to prevent screen capture of a region of the screen at the endpoint, wherein the region of the screen is determined from the sensitive region information.

Example 18 includes the subject matter of any of Examples 15 through 17, wherein the process further includes, responsive to a determination that no sensitive application is visible on the screen, disabling screen capture protection on the virtual desktop session.

Example 19 includes the subject matter of Example 18, wherein disabling the screen capture protection includes sending a disable notification to the endpoint to disable the screen capture protection at the endpoint.

Example 20 includes the subject matter of Example 18, wherein disabling the screen capture protection includes sending a disable notification to the endpoint to disable a region-based screen capture protection at the endpoint.

Example 21 includes the subject matter of any of Examples 15 through 20, wherein the process also includes, responsive to a reconnect of the virtual desktop session: responsive to a determination that at least one sensitive application is visible on a screen, enabling screen capture protection on the virtual desktop session, wherein the determination that the at least one sensitive application is visible is based on the screen capture protection policy.

Example 22 includes a method including: establishing, by a computing device, a virtual desktop session with an endpoint; retrieving, by the computing device, a screen capture protection policy defining one or more sensitive applications for screen capture protection; and, responsive to a determination of a screen capture or screen recording event on the virtual desktop session screen at the endpoint, enabling, by the computing device, screen capture protection on one or more sensitive applications running within the virtual desktop session, wherein the one or more sensitive applications are determined based on the screen capture protection policy.

Example 23 includes the subject matter of Example 22, wherein the determination of the screen capture or screen recording event on the virtual desktop session screen at the endpoint is based on a notification from the endpoint informing of a launch of the screen capture or screen recording event on the virtual desktop session screen at the endpoint.

Example 24 includes the subject matter of any of Examples 22 and 23, wherein enabling screen capture protection on one or more sensitive applications running within the virtual desktop session causes the one or more sensitive applications to be not visible on a screen.

Example 25 includes the subject matter of any of Examples 22 through 24, wherein enabling screen capture protection on one or more sensitive applications running within the virtual desktop session includes invoking a function provided by an underlying operating system (OS) on the one or more sensitive applications.

Example 26 includes the subject matter of any of Examples 22 through 25, further including, responsive to a determination of a completion of the screen capture or screen recording event on the virtual desktop session screen at the endpoint, disabling, by the computing device, screen capture protection on the one or more sensitive applications running within the virtual desktop session.

Example 27 includes the subject matter of Example 26, wherein the determination of the completion of the screen capture or screen recording event on the virtual desktop session screen at the endpoint is based on a notification from the endpoint informing of the completion of the screen capture or screen recording event on the virtual desktop session screen at the endpoint.

Example 28 includes a computing device including a processor and a non-volatile memory storing computer program code that when executed on the processor causes the processor to execute a process. The process includes: establishing a virtual desktop session with an endpoint; retrieving a screen capture protection policy defining one or more sensitive applications for screen capture protection; and, responsive to a determination of a screen capture or screen recording event on the virtual desktop session screen at the endpoint, enabling screen capture protection on one or more sensitive applications running within the virtual desktop session, wherein the one or more sensitive applications are determined based on the screen capture protection policy.

Example 29 includes the subject matter of Example 28, wherein the determination of the screen capture or screen recording event on the virtual desktop session screen at the endpoint is based on a notification from the endpoint informing of a launch of the screen capture or screen recording event on the virtual desktop session screen at the endpoint.

Example 30 includes the subject matter of any of Examples 28 and 29, wherein enabling screen capture protection on one or more sensitive applications running within the virtual desktop session causes the one or more sensitive applications to be not visible on a screen.

Example 31 includes the subject matter of any of Examples 28 through 30, wherein enabling screen capture protection on one or more sensitive applications running within the virtual desktop session includes invoking a function provided by an underlying operating system (OS) on the one or more sensitive applications.

Example 32 includes the subject matter of any of Examples 28 through 31, further including, responsive to a determination of a completion of the screen capture or screen recording event on the virtual desktop session screen at the endpoint, disabling, by the computing device, screen capture protection on the one or more sensitive applications running within the virtual desktop session.

Example 33 includes the subject matter of Example 32, wherein the determination of the completion of the screen capture or screen recording event on the virtual desktop session screen at the endpoint is based on a notification from the endpoint informing of the completion of the screen capture or screen recording event on the virtual desktop session screen at the endpoint.

Example 34 includes a non-transitory machine-readable medium encoding instructions that when executed by one or more processors cause a process to be carried out. The process includes: establishing a virtual desktop session with an endpoint; retrieving a screen capture protection policy defining one or more sensitive applications for screen capture protection; and, responsive to a determination of a screen capture or screen recording event on the virtual desktop session screen at the endpoint, enabling screen capture protection on one or more sensitive applications running within the virtual desktop session, wherein the one or more sensitive applications are determined based on the screen capture protection policy.

Example 35 includes the subject matter of Example 34, wherein the determination of the screen capture or screen recording event on the virtual desktop session screen at the endpoint is based on a notification from the endpoint informing of a launch of the screen capture or screen recording event on the virtual desktop session screen at the endpoint.

Example 36 includes the subject matter of any of Examples 34 and 35, wherein enabling screen capture protection on one or more sensitive applications running within the virtual desktop session causes the one or more sensitive applications to be not visible on a screen.

Example 37 includes the subject matter of any of Examples 34 through 36, wherein enabling screen capture protection on one or more sensitive applications running within the virtual desktop session includes invoking a function provided by an underlying operating system (OS) on the one or more sensitive applications.

Example 38 includes the subject matter of any of Examples 34 through 37, further including, responsive to a determination of a completion of the screen capture or screen recording event on the virtual desktop session screen at the endpoint, disabling, by the computing device, screen capture protection on the one or more sensitive applications running within the virtual desktop session.

Example 39 includes the subject matter of Example 38, wherein the determination of the completion of the screen capture or screen recording event on the virtual desktop session screen at the endpoint is based on a notification from the endpoint informing of the completion of the screen capture or screen recording event on the virtual desktop session screen at the endpoint.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
establishing, by a computing device, a virtual desktop session with an endpoint;
retrieving, by the computing device, a screen capture protection policy defining one or more sensitive applications for screen capture protection; and
responsive to a determination that a sensitive application is visible on a screen, enabling, by the computing device, screen capture protection on the virtual desktop session, wherein the determination that the sensitive application is visible is based on the screen capture protection policy.

2. The method of claim 1, wherein enabling the screen capture protection includes sending an enable notification to the endpoint to enable the screen capture protection at the endpoint, so as to prevent screen capture of the screen at the endpoint.

3. The method of claim 1, wherein enabling the screen capture protection includes sending an enable notification with sensitive region information to the endpoint to enable a region-based screen capture protection at the endpoint, so as to prevent screen capture of a region of the screen at the endpoint, wherein the region of the screen is determined from the sensitive region information.

4. The method of claim 1, further comprising, responsive to a determination that no sensitive application is visible on the screen, disabling, by the computing device, screen capture protection on the virtual desktop session.

5. The method of claim 4, wherein disabling the screen capture protection includes sending a disable notification to the endpoint to disable the screen capture protection at the endpoint.

6. The method of claim 4, wherein disabling the screen capture protection includes sending a disable notification to the endpoint to disable a region-based screen capture protection at the endpoint.

7. The method of claim 1, further comprising, responsive to a reconnect of the virtual desktop session, by the computing device:
responsive to a determination that at least one sensitive application is visible on a screen, enabling screen capture protection on the virtual desktop session, wherein the determination that the at least one sensitive application is visible is based on the screen capture protection policy.

8. A computing device comprising:
a processor; and
a non-volatile memory storing computer program code that when executed on the processor causes the processor to execute a process including:
establishing a virtual desktop session with an endpoint;
retrieving a screen capture protection policy defining one or more sensitive applications for screen capture protection; and
responsive to a determination that a sensitive application is visible on a screen, enabling screen capture protection on the virtual desktop session, wherein the determination that the sensitive application is visible is based on the screen capture protection policy.

9. The computing device of claim 8, wherein enabling the screen capture protection includes sending an enable notification to the endpoint to enable the screen capture protection at the endpoint, so as to prevent screen capture of the screen at the endpoint.

10. The computing device of claim 8, wherein enabling the screen capture protection includes sending an enable notification with sensitive region information to the endpoint to enable a region-based screen capture protection at the endpoint, so as to prevent screen capture of a region of the screen at the endpoint, wherein the region of the screen is determined from the sensitive region information.

11. The computing device of claim 8, wherein the process further comprises, responsive to a determination that no sensitive application is visible on the screen, disabling screen capture protection on the virtual desktop session.

12. The computing device of claim 11, wherein disabling the screen capture protection includes sending a disable notification to the endpoint to disable the screen capture protection at the endpoint.

13. The computing device of claim 11, wherein disabling the screen capture protection includes sending a disable notification to the endpoint to disable a region-based screen capture protection at the endpoint.

14. The computing device of claim 8, wherein the process further comprises, responsive to a reconnect of the virtual desktop session:
responsive to a determination that at least one sensitive application is visible on a screen, enabling screen capture protection on the virtual desktop session, wherein the determination that the at least one sensitive application is visible is based on the screen capture protection policy.

15. A method comprising:
establishing, by a computing device, a virtual desktop session with an endpoint;
retrieving, by the computing device, a screen capture protection policy defining one or more sensitive applications for screen capture protection; and
responsive to a determination of a screen capture or screen recording event on the virtual desktop session screen at the endpoint, enabling, by the computing device, screen capture protection on one or more sensitive applications running within the virtual desktop session, wherein the one or more sensitive applications are determined based on the screen capture protection policy.

16. The method of claim 15, wherein the determination of the screen capture or screen recording event on the virtual desktop session screen at the endpoint is based on a notification from the endpoint informing of a launch of the screen capture or screen recording event on the virtual desktop session screen at the endpoint.

17. The method of claim 15, wherein enabling screen capture protection on one or more sensitive applications running within the virtual desktop session causes the one or more sensitive applications to be not visible on a screen.

18. The method of claim 15, wherein enabling screen capture protection on one or more sensitive applications running within the virtual desktop session includes invoking a function provided by an underlying operating system (OS) on the one or more sensitive applications.

19. The method of claim 15, further comprising, responsive to a determination of a completion of the screen capture or screen recording event on the virtual desktop session screen at the endpoint, disabling, by the computing device, screen capture protection on the one or more sensitive applications running within the virtual desktop session.

20. The method of claim 19, wherein the determination of the completion of the screen capture or screen recording event on the virtual desktop session screen at the endpoint is based on a notification from the endpoint informing of the completion of the screen capture or screen recording event on the virtual desktop session screen at the endpoint.
